(19) United States
(12) Patent Application Publication
(10) Pub. No.: US 2007/0160959 A1
(43) Pub. Date: Jul. 12, 2007

(54) Endodontic device for detecting the root canal morphology

(76) Inventors: Michele Cammisa, Foggia (IT); Caterina Perra, Firenze (IT)

Correspondence Address: POLLACK, P.C., THE CHRYSLER BUILDING, 132 EAST 43RD STREET, SUITE 760, NEW YORK, NY, 10017, US

(21) Appl. No.: 11/578,765

(22) PCT Filed: Apr. 14, 2005
(86) PCT No.: PCT/IT05/00217

§ 371 Date: Oct. 16, 2006

(30) Foreign Application Priority Data
Apr. 16, 2004 (FI) 2004A000091

(51) Int. Cl. A61C 5/02

(52) U.S. Cl. 433/224

(57) ABSTRACT

Endodontic device comprising an endodontic instrument (1) for being inserted in a dental root canal, comprising extensometer means (4), from which a signal can be obtained that is a function of the deformation of the instrument (1), and processing means (6) for receiving and processing the signal to provide a medical operator with information on the stress acting on the instrument (1), and consequently on the morphological characteristics of the dental root canal.

The present invention concerns the field of endodontic techniques, i.e. those therapeutic treatments that make use of instruments for cleansing, shaping, disinfection and filling the root canal system in the root portion of the teeth.

Such techniques allow the functionality of a tooth to be restored when the vital portion (the so-called “pulp”) has been irreversibly damaged by bacteria, chemical agents or traumatic events. For this purpose, instruments of various diameter or conicity, made of Nickel-Titanium alloy, are used, which are mounted on suitable handpieces and rotated continuously with different values of torque, i.e. the maximum turning moment that an instrument cannot exceed in operation.

Both the selection of the working sequence to be followed and that of the working parameters of the instrument (rotation speed, torque, revolutions per minute) are based on the difficulty of the operation, in turn a function of intrinsic anatomical characteristics, or else deriving from the working conditions: degree of curvature of the canal, characteristics of the access cavity, inclination of the instrument, work position, etc. Currently, the evaluation of difficulty, and the consequent operative choices, are basically left to the medical operator's sensitivity and experience, and therefore with varying outcomes from case to case. The operator, moreover, in many cases is not in a condition to have a complete and exact picture of the situation, and must proceed by assumptions that, with hindsight, do not always prove to be correct.

The object of the present invention is to overcome the circumstances just described, by providing an instrument capable of transmitting objective information to the medical operator on the characteristics of the canals to be treated, thus guiding the choices and the working methods with criteria that are no longer simply empirical.

According to the present invention, such an object is achieved with the endodontic device the essential characteristics of which are defined in the first of the appended claims.

Characteristics and advantages of the endodontic device for detecting the root canal morphology according to the present invention will be apparent from the following description of an embodiment thereof, given purely as an example and not for limiting purposes, with reference to the attached drawings in which:

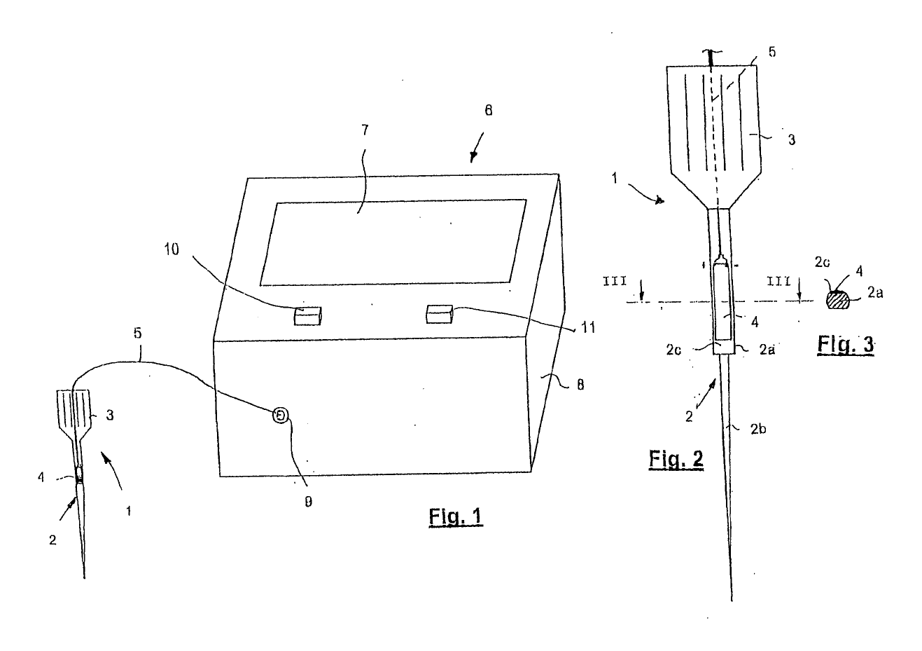

FIG. 1 is a schematic representation of the device according to the invention;

FIG. 2 is an enlarged view of an endodontic instrument of the device of FIG. 1; and

FIG. 3 is a cross section of the instrument taken along lines III-III of FIG. 2.

With reference to the above figures, an endodontic device according to the invention comprises a hand-driven endodontic instrument 1, in the example consisting of a root canal probe 2 with a handle 3 at one end that allows its manipulation by a medical operator. The probe 2, as shown in particular in FIG. 2, consists of a stem made of a shape memory Nickel-Titanium alloy, with a substantially cylindrical tail portion 2a adjacent to the handle 3 and a conical portion 2b culminating with a guide point. The probe 2 has dimensional characteristics suitable for allowing the apex of the root canal of the tooth to be reached, when the shaping treatment of the canal itself—through the cutting instruments established by the clinical protocol—has not yet begun.

On the substantially cylindrical tail portion 2a of the probe 2 a flat face 2c is formed, on which an extensometer 4 is applied, for example through gluing. In the depicted embodiment the extensometer 4 is a resistive element the electrical resistance of which varies in response to its deformation, and then to the deformation of the material with which it is integral. The provision of the extensometer 4, of a type known per se (for example, the precision sensor EA-06-031DE-120 provided by the US company “Measurements Group” of Raleigh, N.C. can be used), does not prevent the sterilisation of the probe (possibly sealed in a suitable envelope), provided that a glue is used having suitable temperature resistance, also in this case according to what can easily be obtained from products on the market.

A bipolar cable 5, terminating with a jack connector (not represented), projects from the extensometer 4 coaxially in the handle 3, and beyond it. The connector allows the connection of the cable 5 to processing means of the signal that can be gained from the extensometer 4, arranged in a central unit 6. The connection through the cable 5 can obviously be replaced by a wireless connection. The processing means, of a type comparable to those used for generic applications of the extensometers and similar, allow the variations in resistance of the extensometer 4 to be detected with the maximum precision, translating them into a measurement signal of the deformation, and consequently of the stress acting on the probe 2. The signal can be visualised or in any case interpreted by the medical operator.

For such a purpose, the central unit 6 can, like in the example schematically illustrated, comprise a display 7 for displaying the measurement of the stress, on the top side of a box-shaped body 8. The latter, as well as a female connector 9 for the connection of the cable 5, can also have buttons for controlling the device, for example and simply an on/off button 10 and a reset button 11. The body 8 also houses electrical power supply means, preferably comprising a battery system (not shown).

With the device according to the invention, the medical operator can therefore have a measurement, at the least indicative, of the stress acting on the root canal probe 2, a stress that can be due both to the direction of insertion of the probe itself in the root canal, and to the curvature of the latter. As far as the first aspect is concerned, this results in the possibility of identifying an optimal working direction, i.e. of minimum stress, for the rotating cutting instruments, guiding the operator in the elimination of the coronal interference and suggesting the most correct method of insertion of the instrument. Then, with reference to the second aspect, it is clear that, by rotating the probe 2 around its own axis inside the channel, a three-dimensional picture of the criticality of the canal itself can be worked out, which can be used to modify or establish operating sequences intended for individual clinical cases, as well as to suggest the setting of different working parameters of the cutting instrument (in particular, the torque values) according to the specific circumstances. The object of the invention, as mentioned in the introductory part, is thus fully achieved.

The processing means can also carry out a translation of the stress directly in an angular indication of the curvature of the root canal, with a preset algorithm, worked out experimentally. Alternatively, a correlation graph between measured stress and angulation value (or other geometric magnitude of the canal) can be serigraphed on the box-shaped body 8, so as to be always and immediately visible to the operator. The measurement of the stress (and/or of the angulation), instead of exact and continuous through the display, can be provided discretely, through a series of LEDs progressively lighting up as the detected value increases, accompanied or not by sound indications.

The invention can in general be reduced to practice with embodiments different from the one of the example. The probe 2 can take up the form of an actual cutting instrument for endodontic use, even not hand-driven and of whatever material. The resistive extensometer 4 can be replaced with other extensometer means suitable to the purpose, such as a semi-conductor or piezoelectric extensometer or furthermore, more generally, an active capacitative, inductive or electronic element capable of detecting with the required precision the deformation of the materials as a function of the variations of its electrical/electronic characteristics.

The association of the extensometer with the endodontic instrument, as well as by gluing, can be carried out with alternative methods; in particular, the extensometer means can be formed directly on the surface of the tool with known technologies such as the application of circuitry (for example made from copper) by photoengraving, or by serigraphy with conductive inks.

The obtained measurement signal can also be supplied (with transmission of the signal through whatever known protocol such as serial, wireless or whatever else) to other machines by endodontics such as micromotors, apical localisers, fatigue measurers, assemblies and filling systems (i.e. handpiece devices carrying a heating point to be introduced into the root canal to soften the dental filling material). The machines can thus undergo automatic adjustments according to the measurements provided by the device.

The device can, moreover, be totally or partially integrated in the aforementioned apparatuses, so that the invention adds an advantageous functional characteristic to the products already present on the market. The rotation of the probe 2, or similar endodontic instrument, can also be carried out by a micromotor. In this case the handle 3, instead of being intended for direct manipulation, shall be shaped so as to be engageable in a dental prophy angle, i.e. a handpiece suitable for driving the endodontic instrument into low speed rotation.

Other variants and/or modifications can be brought to the endodontic device for detecting the root canal morphology according to the present invention, without for this reason departing from the scope of protection of the invention itself as defined in the appended claims.

What is claimed is:

1. An endodontic device comprising an instrument for insertion in a dental root canal of a patient, the device including an extensometer associated with the instrument for providing a signal that is a function of the deformation of the instrument, and a processor for receiving and processing the signal so as to provide a medical operator with information on forces acting on the instrument, and consequently on the morphological characteristics of the dental root canal.

2. The device set forth in claim 1, wherein the instrument has dimensional characteristics suitable for allowing an apex of the root canal to be reached and rotation about its axis inside the canal itself, and further comprises a conical portion culminating with a guide point and a substantially cylindrical tail portion with a relatively flat face on which the extensometer is applied.

3. The device set forth in claim 2, wherein a handle extends from the cylindrical tail portion for allowing manipulation of the instrument by the medical operator.

4. The device set forth in claim 2, wherein an engagement portion of the instrument in a dental prophy angle extends from the cylindrical tail portion for driving the tool rotationally at a relatively low speed.

5. The device set forth in claim 1, wherein the instrument includes a selected alloy.

6. The device set forth in claim 5, wherein the alloy is a shape memory Nickel-Titanium alloy.

7. The device set forth in claim 1, wherein the extensometer comprises a resistive semiconductor or piezoelectric extensometer.

8. The device set forth in claim 1, wherein the extensometer is mounted to the instrument by glue having a selected temperature resistance such as to allow sterilization of the instrument.

9. The device set forth in claim 1, wherein the extensometer is applied directly to the instrument using photoengraving or seriographic procedures.

10. The device set forth in claim 1, wherein the processor is arranged in a central unit, communicating with the entensometer and comprising, in addition to an electrical power supply, a display for showing the deformation signal and/or stress information.

11. The device set forth in claim 10, wherein the central unit is wired to the extensometer.

12. The device set forth in claim 10, wherein the central unit and the extensometer communicate with one another through a wireless connection.

13. The device set forth in claim 9 to 12, wherein a graph showing the correlation between the measured stress and the value corresponding to the relative size of the canal is applied to the central unit.

14. The device set forth in claim 1, wherein the processor is suitable for translating the deformation signal so as to provide information on the morphological characteristics of the canal directly to the medical operator.

15. The device set forth in claim 1, further comprising a device for transmitting the signal, or of information derived from it, to an endodontic machine such as a micromotor, an apical localizer, a fatigue measurer or a filling system.

16. The device set forth in claim 1, associated or integrated with an endodontic machine such as a micromotor, an apical localizer, a fatigue measurer or a filling system.
